(19) United States
(12) Patent Application Publication
(10) Pub. No.: US 2023/0071944 A1
(43) Pub. Date: Mar. 9, 2023

(54) PAYMENT APPARATUS AND PAYMENT METHOD FOR THE SAME

(71) Applicant: TOSHIBA TEC KABUSHIKI KAISHA, Tokyo (JP)

(72) Inventors: Yuji HAYASHI, Tagata Shizuoka (JP); Eisuke AOYAMA, Yao Osaka (JP)

(21) Appl. No.: 17/719,732

(22) Filed: Apr. 13, 2022

(30) Foreign Application Priority Data
Sep. 7, 2021 (JP) 2021-145289

(51) Int. Cl. G06Q 20/32; G06K 7/14

(52) U.S. Cl. CPC G06Q 20/3276; G06Q 20/322; G06K 7/1413; G06K 7/1417

(57) ABSTRACT

According to an embodiment, a payment apparatus acquires a data file in which data relating to sale of a commodity is recorded, the data being input through a terminal operated by a customer in a sales floor. The payment apparatus provides the customer with a notification for determining whether or not the customer has service specifying information for specifying a service to be provided to the customer on condition that the data file is acquired. The payment apparatus receives an input of the service specifying information when an instruction input indicating that the customer has the service specifying information is received in responses to the notification.

### CROSS-REFERENCE TO RELATED APPLICATIONS

This application is based upon and claims the benefit of priority from the prior Japanese Patent Application No. 2021-145289, filed on Sep. 7, 2021, the entire contents of which are incorporated herein by reference.

### FIELD

An embodiment described herein generally relates to a payment apparatus, a program for causing a computer to function as the payment apparatus, and a payment method.

### BACKGROUND

In sales floors where commodities are displayed, a customer operates a terminal such as a smartphone by himself/herself to input the data relating to the commodities to be purchased by himself/herself. The customer also operates a dedicated payment apparatus to pay for the commodities to be purchased by himself/herself. Such a transaction processing system is already known. Employing this type of transaction processing system by retailers such as supermarkets eliminates the need for inputting the data relating to commodities to be purchased by customers to payment apparatuses. This provides advantages such as shortening the time required for payment.

Meanwhile, many retailers employ a reward point service system for sales promotion. This system is a service for calculating reward points in accordance with the content of transactions with customers who are members and for providing the reward points to the corresponding customers. The customers can obtain a variety of benefits by accumulating the reward points provided. However, in order to receive reward points, the customers need to input service specifying information for identifying the customer as a member of the reward point service system, e.g., a member number, to the payment apparatus before the payment. So, in the case of the transaction processing system described above, the customer operates the payment apparatus by himself/herself, and the customer sometimes forgets to input the member number to the payment apparatus and no reward points are provided.

In view of such circumstances, there is a need for a payment apparatus capable of surely executing processing of providing a service in a transaction with a customer who can receive a service such as reward points.

### BRIEF DESCRIPTION OF THE DRAWINGS

FIG. 1 is a block diagram showing a transaction processing system according to an embodiment.

FIG. 2 is a sequence diagram for describing the main functions of a shopping support terminal and a virtual point-of-sales (POS) server according to the embodiment.

FIG. 3 is a block diagram showing a main circuit configuration of a checkout machine according to the embodiment.

FIG. 4 is a flowchart showing information processing executed in accordance with a payment program by a processor of the checkout machine according to the embodiment.

FIG. 5 is a flowchart showing information processing executed in accordance with the payment program by the processor of the checkout machine according to the embodiment.

FIG. 6 is a flowchart showing information processing executed in accordance with the payment program by the processor of the checkout machine according to the embodiment.

FIG. 7 is a diagram showing an example of a reward point confirmation screen displayed on a touch panel of the checkout machine according to the embodiment.

FIG. 8 is a flowchart showing a part of information processing executed in accordance with the payment program by the processor of the checkout machine according to another embodiment.

### DETAILED DESCRIPTION

According to one embodiment, a payment apparatus performs payment processing on the basis of a data file in which data relating to sale of a commodity is recorded, the data being input through a terminal operated by a customer in a sales floor. The payment apparatus includes a communication interface, an input device, a memory, and a processor. The communication interface exchanges the data with a server that creates the data file. The input device displays a screen for providing a notification to the customer and receives an instruction input made by the customer in response to the notification. The memory stores service specifying information for specifying a service to be provided to the customer. The processor acquires the data file from the server via the communication interface. The processor provides the customer with a notification for determining whether or not the customer has the service specifying information for specifying a service to be provided to the customer using the input device on condition that the data file is acquired, and waits for an instruction input made by the customer as to whether the customer has the service specifying information. The processor acquires the service specifying information and causes the memory to store the service specifying information when the input device receives an instruction input indicating that the customer has the service specifying information in responses to the notification. The processor performs processing for providing the service specified by the stored service specifying information to the customer. Further, the processor executes payment processing on a basis of the data of the acquired data file after the input device receives an instruction input indicating that the customer does not have the service specifying information or receives an input of the service specifying information in responses to the notification.

Hereinafter, one embodiment will be described with reference to the drawings. The same reference symbols in the drawings will denote the same or similar portions. In this embodiment, in sales floors where commodities are displayed, a customer operates a terminal by himself/herself to input the data relating to commodities to be purchased to the terminal by himself/herself. The customer also operates a dedicated payment apparatus by himself/herself to pay for the commodities to be purchased. This embodiment exemplifies the transaction processing system as described above. A store in which such a transaction processing system is established is assumed to employ a reward point service system. The reward point service system includes a company's reward point service system and a common reward point service system. The company's reward point service system is a service for providing customers with reward points that can be used only at specific stores. The common reward point service system is a service for providing customers with reward points that can be commonly used for a plurality of stores or services. The stores employ both their own reward point service systems and the common reward point service system.

Hereinafter, the reward points of the company's reward point service system will be referred to as company's reward points. Further, the reward points of the common reward point service system will be referred to as common reward points. Customers who receive company's reward points have reward point cards. In the company's reward point card, a company's reward point member number is recorded as service specifying information. Customers who receive common reward points have common reward point cards. In the common reward point card, a common reward point member number is recorded as service specifying information.

[Description on Configuration of Transaction Processing System]

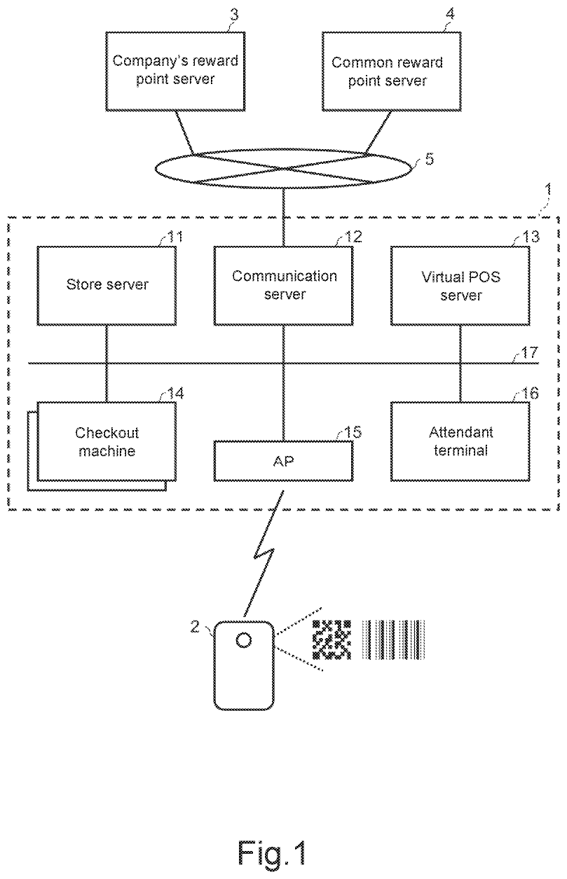

FIG. 1 is a block diagram showing a transaction processing system 1 according to an embodiment. This embodiment includes the transaction processing system 1, a shopping support terminal 2, a company's reward point server 3, a common reward point server 4, and a communication network 5. The communication network 5 is a wide area network using a public line or a dedicated line as a relay network and using a wired local area network (LAN), a wireless LAN, a mobile communication network, a cellular-phone communication network, or the like as an access network. The communication network 5 may be a narrow area network using a wired or wireless LAN or the like.

The company's reward point server 3 is a computer specialized in the management service of the company's reward points. The company's reward point server 3 includes a database for storing information such as cumulative reward points in association with the company's reward point member number.

The common reward point server 4 is a computer specialized in the management service of the common reward points. The common reward point server 4 includes a database for storing information such as cumulative reward points in association with the common reward point member number.

The shopping support terminal 2 is a terminal used by a customer to input data relating to a commodity to be purchased to the terminal by himself/herself. The shopping support terminal 2 is a portable terminal including an input device, a display device, a wireless unit, and an imaging device necessary for reading a code symbol such as a two-dimensional code or a barcode. For example, a commercially available smartphone including a digital camera, a tablet terminal, or the like can be used as the shopping support terminal 2.

The transaction processing system 1 includes a store server 11, a communication server 12, a virtual point-of-sales (POS) server 13, a checkout machine 14, an access point 15, and an attendant terminal 16. The store server 11, the communication server 12, the virtual POS server 13, the checkout machine 14, the access point 15, and the attendant terminal 16 are interconnected by a communication network 17. The communication network 17 is typically a wired or wireless LAN.

The store server 11 is a computer that supports general tasks in the store. For such a support, the store server 11 manages a variety of databases including a commodity database. The commodity database is the collection of commodity records in which the data of each commodity sold in the store is described. The commodity records include commodity data such as a commodity code, a price, and a commodity name. The commodity code is a unique identification code set for each commodity to individually identify the commodity. Each commodity is typically accompanied by a barcode representing the commodity code.

The communication server 12 is a server for supporting data communication performed with the company's reward point server 3 or the common reward point server 4 connected via the communication network 5.

The virtual POS server 13 is a computer that cooperates with the shopping support terminal 2 to provide support for making it appear as if a well-known POS terminal operates. For example, the virtual POS server 13 has the following three functions. The first function is a function of registering commodity sales data of the commodity identified by the commodity code input via the shopping support terminal 2 in a transaction file to be described later. The second function is a function of causing the display device of the shopping support terminal 2 to display a registration screen created on the basis of the commodity sales data registered in the transaction file. The third function is a function of causing the display device of the shopping support terminal 2 to display a checkout barcode in response to a checkout instruction from the shopping support terminal 2. The checkout barcode will be described later.

The checkout machine 14 is a dedicated payment apparatus that enables a customer who has input the data relating to the commodities to be purchased using the shopping support terminal 2 by himself/herself to make a payment for the commodities to be purchased by himself/herself. A plurality of checkout machines 14 is connected to the communication network 17. The payment method is not particularly limited. Well-known payment methods such as cash payment, credit card payment, electronic money payment, reward point payment, and code payment (also referred to as mobile payment, smartphone payment, etc.) may be utilized.

The access point 15 is a communication facility installed in the store as a relay base, which is used when each server (store server 11, communication server 12, virtual POS server 13, or the like) of the transaction processing system 1 performs data communication with the shopping support terminal 2 through a wireless LAN. The wireless LAN conforms to, for example, the Wi-Fi (registered trademark) standard. Note that FIG. 1 shows only one access point 15 in the transaction processing system 1, but the number of access points 15 is not limited. A plurality of access points 15 may be connected to the communication network 17 depending on the size of the store or the like.

The attendant terminal 16 is a terminal for a store clerk called an attendant to monitor the states of the shopping support terminal 2 and the checkout machine 14.

The configuration of the transaction processing system 1 is not limited to that shown in FIG. 1. For example, the number of servers may be reduced by one server implementing the functions of at least two servers of the store server 11, the communication server 12, and the virtual POS server 13. Further, in addition to the checkout machine 14, a well-known POS terminal in which a store clerk performs a registration operation and a payment operation of commodities to be purchased, or a semi-self-type registration machine and checkout machine in which a registration machine and a checkout machine are separated from each other, and a store clerk performs a registration operation of commodities to be purchased on the registration machine and a customer performs a payment operation on the checkout machine by himself/herself, may be connected to the communication network 17.

[Description on Functions of Shopping Support Terminal and Virtual POS Server]

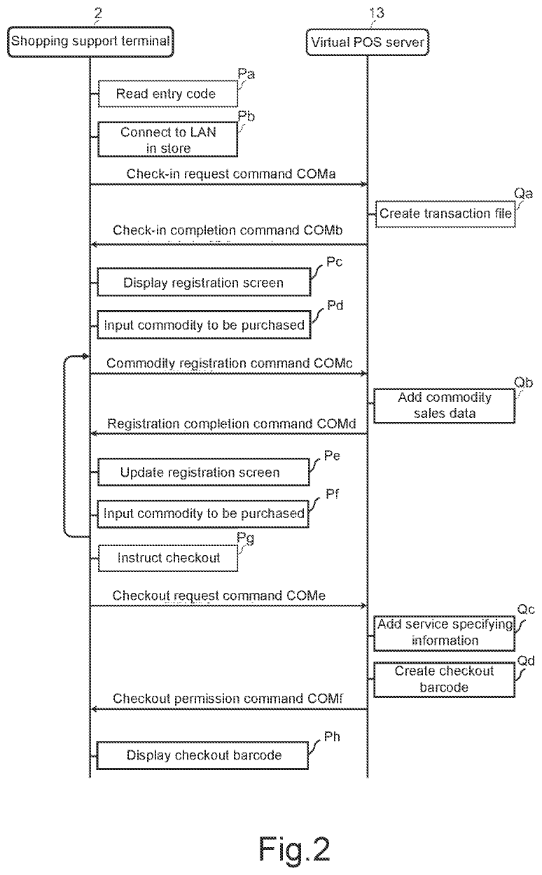

Next, the main functions of the shopping support terminal 2 and the virtual POS server 13 will be described with reference to the sequence diagram of FIG. 2.

First, for example, a customer who wants to use a smartphone as the shopping support terminal 2 installs a shopping support application program directed to a store in which the transaction processing system 1 is established, i.e., a so-called shopping application, on the smartphone. The customer can use the smartphone as the shopping support terminal 2 by performing user registration. Note that in the user registration the customer can register service specifying information for specifying the company's reward point service system of that store, that is, a company's reward point member number. The registration of the company's reward point member number is optionally performed. The registered company's reward point member number is stored in the memory of the shopping support terminal 2.

The customer who carries the shopping support terminal 2 activates the shopping application before entering the store. Then, as indicated by a function Pa, the shopping support terminal 2 activates the camera and reads an entry code. The entry code is setting information relating to the store, which is coded by a predetermined two-dimensional code system, and is prepared at the entrance of the store, for example. The setting information includes, for example, parameters necessary for the shopping support terminal 2 to communicate with the access point 15 using the wireless LAN, information relating to the operation restriction of the shopping support terminal 2, or the like. The customer causes the camera of the shopping support terminal 2 to read the entry code.

When reading the entry code, the shopping support terminal 2 is connected to the access point 15 using the wireless LAN as indicated by a function Pb. When the shopping support terminal 2 is connected to the access point 15, the shopping support terminal 2 transmits a check-in request command COMa to the virtual POS server 13. The check-in request command COMa is transmitted from the access point 15 to the virtual POS server 13 via the communication network 17. The check-in request command COMa includes terminal identification information of the shopping support terminal 2. The terminal identification information is unique information different from that of a shopping support terminal 2 used by another customer. For example, a program ID of the shopping application installed on the shopping support terminal 2 is used as the terminal identification information.

Upon receiving the check-in request command COMa, the virtual POS server 13 creates a transaction file as indicated by a function Qa. The transaction file is a data file for storing commodity sales data of a commodity identified by a commodity code input via the shopping support terminal 2. The transaction file is created for each shopping support terminal 2. Each transaction file is associated with the terminal identification information of the shopping support terminal 2.

The virtual POS server 13, which has created the transaction file, transmits a check-in completion command COMb to the shopping support terminal 2 that is the transmission source of the check-in request command COMa. The check-in completion command COMb is transmitted from the access point 15 to the shopping support terminal 2 via the communication network 17.

The shopping support terminal 2, which has received the check-in completion command COMb, causes the display device to display a registration screen as indicated by a function Pc. The registration screen is a screen for displaying a commodity name, a price, and the like of the commodity identified by the commodity code input via the shopping support terminal 2. A commodity registration button is displayed on the registration screen.

The customer sets the shopping support terminal 2 in the shopping cart or carries the shopping support terminal 2 to walk around the sales floor where commodities are displayed. When finding a commodity to be purchased, the customer operates the commodity registration button on the registration screen by touching it. Hereinafter, an operation by touching may be simply referred to as a touch operation. When the commodity registration button receives the customer's operation, the shopping support terminal 2 inputs the data of the commodity to be purchased as indicated by a function Pd. For example, the shopping support terminal 2 is in a standby state for reading a barcode. The customer causes the camera of the shopping support terminal 2 to read the barcode attached to the commodity to be purchased. When the camera reads the barcode of the commodity, the shopping support terminal 2 inputs the commodity code represented by the barcode as the data of the commodity to be purchased.

Note that a barcode-free button is also displayed on the registration screen. If the commodity to be purchased is not provided with a barcode, the customer operates the barcode-free button. When the barcode-free button receives the customer's operation, the shopping support terminal 2 causes the display device to display a list of barcode-free commodities. The customer selects the commodity to be purchased from the displayed list. When the commodity to be purchased is selected, the shopping support terminal 2 inputs the commodity code of the selected commodity as the data of the commodity to be purchased.

When the data of the commodity to be purchased is input, the shopping support terminal 2 transmits a commodity registration command COMc to the virtual POS server 13. The commodity registration command COMc is transmitted from the access point 15 to the virtual POS server 13 via the communication network 17. The commodity registration command COMc includes the terminal identification information of the shopping support terminal 2 and the data of the commodity to be purchased.

As indicated by a function Qb, the virtual POS server 13, which has received the commodity registration command COMc, adds the commodity sales data to the transaction file associated with the terminal identification information of the shopping support terminal 2 that is the transmission source of the commodity registration command COMc, on the basis of the data of the commodity to be purchased. The commodity sales data is data including a commodity code of a commodity to be purchased, a commodity name, a price, the number of commodities sold, the sales amount, etc. The sales amount is the amount obtained by multiplying the price by the number of commodities sold.

The virtual POS server 13, which has added the commodity sales data to the transaction file, transmits a registration completion command COMd to the shopping support terminal 2 that is the transmission source of the commodity registration command COMc. The registration completion command COMd is transmitted from the access point 15 to the shopping support terminal 2 via the communication network 17.

The shopping support terminal 2, which has received the registration completion command COMd, updates the registration screen as indicated by a function Pe. In other words, the shopping support terminal 2 updates the registration screen such that the commodity name, the price, and the like in the commodity sales data added to the transaction file are displayed. The updated registration screen displays a checkout button as well as the commodity registration button and the like. After updating the registration screen, the shopping support terminal 2 waits for the data of a commodity to be purchased to be input as indicated by a function Pf or for the checkout button to be operated as indicated by a function Pg.

When finding the next commodity to be purchased, the customer operates the commodity registration button. When the commodity registration button receives the customer's operation, the shopping support terminal 2 inputs the data of the commodity to be purchased. The shopping support terminal 2 then transmits a commodity registration command COMc to the virtual POS server 13. The functions of the shopping support terminal 2 and the virtual POS server 13 thereafter are the same as those described above.

The customer who has finished shopping on the sales floor operates the checkout button on the registration screen to give a checkout instruction. When the checkout button receives the customer's operation, the shopping support terminal 2 transmits a checkout request command COMe to the virtual POS server 13. The checkout request command COMe is transmitted from the access point 15 to the virtual POS server 13 via the communication network 17. The checkout request command COMe includes the terminal identification information of the shopping support terminal 2. Further, if the company's reward point member number is stored in the memory of the shopping support terminal 2, the company's reward point member number is also included in the checkout request command COMe.

If the checkout request command COMe includes the company's reward point member number, the virtual POS server 13, which has received such a checkout request command COMe, adds the company's reward point member number or the service specifying information to the transaction file associated with the terminal identification information of the shopping support terminal 2 that is the transmission source of the checkout request command COMe, as indicated by a function Qc. If the checkout request command COMe does not include the company's reward point member number, the virtual POS server 13 does not execute the function Qc.

Subsequently, the virtual POS server 13 creates a unique checkout barcode, as indicated by a function Qd. For example, the virtual POS server 13 creates a checkout barcode in which the terminal identification information of the shopping support terminal 2 that is the transmission source of the checkout request command COMe is barcoded in a predetermined barcode system. The virtual POS server 13, which has created the checkout barcode, transmits a checkout permission command COMf to the shopping support terminal 2 that is the transmission source of the checkout request command COMe. The checkout permission command COMf is transmitted from the access point 15 to the shopping support terminal 2 via the communication network 17. The checkout permission command COMf includes the data of the checkout barcode.

The shopping support terminal 2, which has received the checkout permission command COMf, causes the display device to display an image of the checkout barcode, as indicated by a function Ph. This checkout barcode is used for payment in the checkout machine 14. Next, the checkout machine 14 will be described.

[Description on Configuration of Checkout Machine]

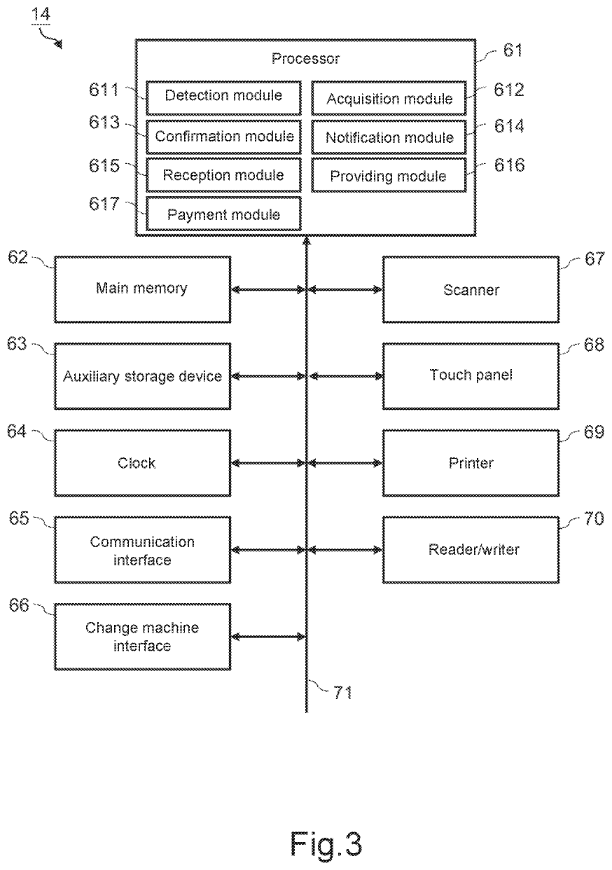

FIG. 3 is a block diagram showing a main circuit configuration of the checkout machine 14. The checkout machine 14 includes a processor 61, a main memory 62, an auxiliary storage device 63, a clock 64, a communication interface 65, a change machine interface 66, a scanner 67, a touch panel 68, a printer 69, a reader/writer 70, a system transmission line 71, and the like. The system transmission line 71 includes an address bus, a data bus, a control signal line, and the like. The system transmission line 71 connects the processor 61 and the other units directly or via a signal input/output circuit, and transmits data signals exchanged between them.

The checkout machine 14 constitutes a computer by connecting the processor 61, the main memory 62, the auxiliary storage device 63, the clock 64, and the communication interface 65 to one another via the system transmission line 71. In the checkout machine 14, the computer is connected to device interfaces or devices such as the change machine interface 66, the scanner 67, the touch panel 68, the printer 69, and the reader/writer 70 via the system transmission line 71.

The processor 61 corresponds to the central portion of the computer. The processor 61 controls each unit in accordance with an operating system or application program to implement various functions as the checkout machine 14. The processor 61 is, for example, a central processing unit (CPU).

The main memory 62 corresponds to the main memory portion of the computer. The main memory 62 includes a non-volatile memory area and a volatile memory area. The main memory 62 stores the operating system or application program in the non-volatile memory area. The main memory 62 may store, in the non-volatile or volatile memory area, the data necessary for the processor 61 to perform processing for controlling each unit. The volatile memory area of the main memory 62 is used as a work area in which data is appropriately rewritten by the processor 61. The non-volatile memory area is, for example, a read only memory (ROM). The volatile memory area is, for example, a random-access memory (RAM).

The auxiliary storage device 63 corresponds to the auxiliary storage portion of the computer. For example, an electric erasable programmable read-only memory (EEPROM), a hard disk drive (HDD), or a solid-state drive (SSD) is used as the auxiliary storage device 63. The auxiliary storage device 63 stores data used by the processor 61 to perform various kinds of processing, data created by processing in the processor 61, and the like. The auxiliary storage device 63 sometimes stores the above-mentioned application program.

The clock 64 measures the date and time. The processor 61 processes the date and time obtained by the clock 64 as the current date and time.

The communication interface 65 performs data communication with the store server 11, the communication server 12, the virtual POS server 13, the access point 15, the attendant terminal 16, and the like connected via the communication network 17.

The change machine interface 66 constitutes an interface with an automated change machine (not shown). The change machine interface 66 inputs amount data of money, which has been input to the automated change machine, from the automated change machine. The change machine interface 66 outputs change data from the checkout machine 14 to the automated change machine. The automated change machine that has input the change data automatically pays out the money corresponding to the change data as a change.

The scanner 67 is an example of a reader that reads code symbols such as barcodes and two-dimensional codes. The scanner 67 may be of a type that reads a code symbol by scanning with a laser beam, or may be of a type that reads a code symbol from an image captured by an imaging device.

The touch panel 68 is a device serving as both of an input device and a display device. The touch panel 68 is an input device that displays information to a customer who is an operator of the checkout machine 14 and receives an operation input made by the customer.

The printer 69 issues a receipt by printing various character strings, images, and the like on a receipt sheet. As this type of printer 69, for example, a thermal printer, a dot impact printer, or the like can be used.

The reader/writer 70 has a function of reading data recorded on a medium such as a card or a smart phone and a function of writing data to the medium. The card may include reward point cards called company's reward point cards, common reward point cards, and the like, in addition to cards for payment such as credit cards, debit cards, electronic money cards, and prepaid cards. The reader/writer 70 may be any device of a magnetic type, a contact type, or a contactless type, and may include a plurality of types of devices.

In the checkout machine 14 having such a configuration, the processor 61 functions as a detection module 611, an acquisition module 612, a confirmation module 613, a notification module 614, a reception module 615, a providing module 616, and a payment module 617.

The detection module 611 detects the code associated with the transaction file from the shopping support terminal 2. As described above, the transaction file is associated with the terminal identification information of the shopping support terminal 2. When the checkout button is operated on the shopping support terminal 2, a checkout barcode in which such terminal identification information is barcoded in a predetermined barcode system is displayed on the display device of the shopping support terminal 2. Specifically, the detection module 611 detects the checkout barcode displayed on the display device of the shopping support terminal 2.

The acquisition module 612 acquires the transaction file in which the data relating to the sale of the commodities, which is input using the shopping support terminal 2 operated by the customer in the sales floor, is recorded. Specifically, the acquisition module 612 acquires the transaction file associated with the code detected by the detection module 611 from the virtual POS server 13.

The confirmation module 613 determines whether or not the transaction file acquired by the acquisition module 612 includes service specifying information for specifying a service to be provided to the customer, that is, a company's reward point member number or a common reward point member number.

The notification module 614 provides a notification for determining whether or not the customer has the service specifying information via the touch panel 68 on condition that the transaction file is acquired by the acquisition module 612. The notification module 614 waits for an instruction input to be made by the customer as to whether the customer has the service specifying information. Note that the notification module 614 provides the above-mentioned notification if the transaction file does not include the company's reward point member number or the common reward point number.

When the touch panel 68 receives an instruction input indicating that the customer has the service specifying information in response to the notification provided by the notification module 614, the reception module 615 receives the input of the service specifying information. Specifically, the reception module means receives the input of the company's reward point member number or the common reward point member number.

The providing module 616 performs processing for providing the customer with a service, which is specified by the service specifying information input by the reception module 615. Specifically, if the reception module 615 receives the input of the company's reward point member number, the providing module 616 executes processing of giving company's reward points identified by the company's reward point member number (processing of giving the company's reward points to the customer). If the reception module 615 receives the input of the common reward point member number, the providing module 616 executes processing of giving common reward points identified by the common reward point member number (processing of giving the common reward points to the customer).

The payment module 617 executes payment processing on the basis of the data of the transaction file acquired by the acquisition module 612. The payment module 617 executes payment processing when an instruction input indicating that the customer does not have the service specifying information is received in response to the notification provided by the notification module 614. Further, the payment module 617 executes payment processing when the input of the service specifying information is received by the reception module 615.

The functions of the detection module 611, the acquisition module 612, the confirmation module 613, the notification module 614, the reception module 615, the providing module 616, and the payment module 617 are all implemented by the information processing executed by the processor 61 in accordance with a payment program. The payment program is a type of application program stored in the main memory 62 or the auxiliary storage device 63. The method of installing the payment program on the main memory 62 or the auxiliary storage device 63 is not particularly limited. The payment program may be recorded on a removable recording medium or may be distributed via communication over the network 17, to be installed on the main memory 62 or the auxiliary storage device 63. The recording medium may have any form such as a CD-ROM or a memory card as long as the recording medium can store the program and the apparatus can read it.

[Description on Operation of Checkout Machine]

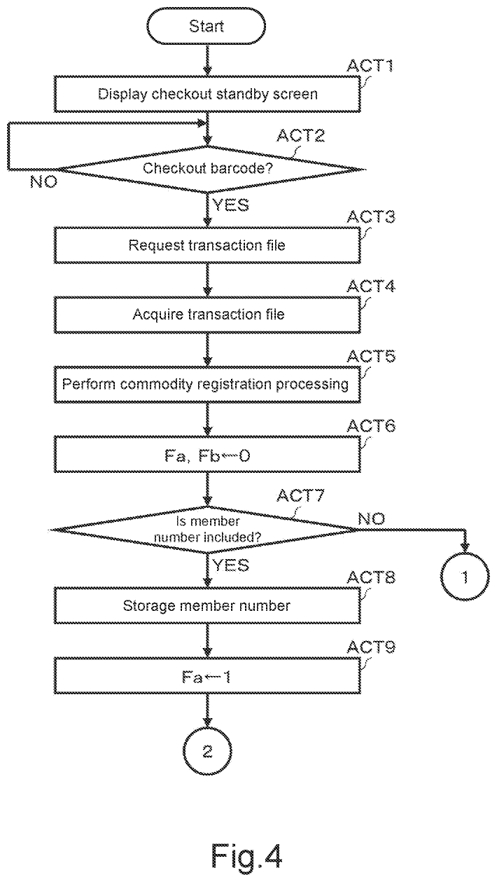

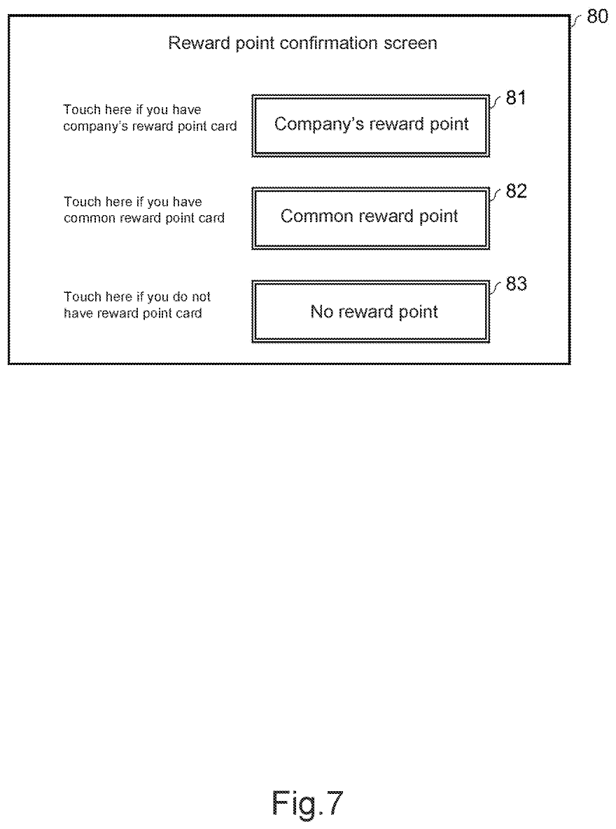

FIGS. 4 to 6 are flowcharts showing information processing executed by the processor 61 in accordance with the payment program. FIG. 7 is a diagram showing an example of a screen displayed on the touch panel 68 that is a display device of the checkout machine 14. The main operation of the checkout machine 14 will be described below with reference to the drawings. Note that the operation to be described below is an example. If the same effect can be achieved, the procedure or the content of the processing can be appropriately changed.

In ACT1 of FIG. 4, the processor 61 causes the touch panel 68 to display a checkout standby screen. The checkout standby screen is, for example, a screen displaying a guidance for instructing the customer who has registered the commodity to be purchased using the shopping support terminal 2 to use the scanner 67 to read the checkout barcode displayed on the display device of the shopping support terminal 2. In ACT2, the processor 61 waits for the checkout barcode to be input by determining whether or not the checkout barcode is input.

After finishing the shopping in the sales floor, the customer operates the checkout button and confirms that the checkout barcode is displayed on the display device of the shopping support terminal 2, and then moves to the location where the checkout machine 14 is installed. The customer then passes the checkout barcode over the scanner 67 of the checkout machine 14 on which the checkout standby screen is displayed. When the checkout barcode is passed over the scanner 67, the checkout barcode is read by the scanner 67.

When the checkout barcode is read by the scanners 67, in ACT2, the processor 61 determines that the checkout barcode has been input (Yes in ACT2). The processing of the processor 61 then proceeds to ACT3. In ACT3, the processor 61 transmits a request command for requesting a transaction file to the virtual POS server 13 via the communication interface 65. This request command includes the input checkout barcode. As described above, the checkout barcode is obtained by barcoding the terminal identification information of the shopping support terminal 2. Meanwhile, the transaction file stored in the virtual POS server 13 is associated with the terminal identification information of the shopping support terminal 2. The processor 61 then requests the transaction file associated with the terminal identification information obtained from the checkout barcode. Upon receiving the request command, the virtual POS server 13 transmits the transaction file associated with the terminal identification information to the checkout machine 14.

In ACT4, the processor 61 acquires the transaction file transmitted from the virtual POS server 13 via the communication interface 65. In ACT5, the processor 61 executes commodity registration processing. In other words, the processor 61 registers the sales data of the commodities to be purchased in a sales totaling memory on the basis of the commodity sales data stored in the transaction file. By this registration processing, the total amount of the transaction is calculated. The sales totaling memory is formed in the volatile memory area of the main memory 62.

Here, the processor 61 implements the function as the detection module 611 by the processing in ACT2. Further, the processor 61 implements the function as the acquisition module 612 by the processing in ACT5 and ACT4.

After the commodity registration processing, in ACT6, the processor 61 resets a company's reward point flag Fa and a common reward point flag Fb to “0”. The company's reward point flag Fa and the common reward point flag Fb are both 1-bit data stored in the volatile memory area of the main memory 62. The company's reward point flag Fa is a flag for identifying whether or not the company's reward points are provided, and in this embodiment, it is set to “0” when the reward points are not provided and set to “1” when the reward points are provided. The common reward point flag Fb is a flag for identifying whether or not the common reward points are provided, and in this embodiment, it is set to “0” when the common reward points are not provided and set to “1” when the common reward points are provided.

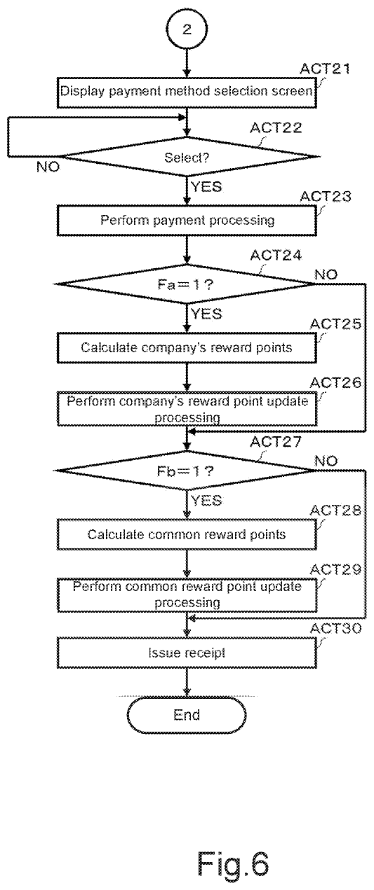

In ACT7, the processor 61 determines whether or not the transaction file includes service specifying information, i.e., a company's reward point member number. If it is determined that the transaction file includes a company's reward point member number (YES in ACT7), the processing of the processor 61 proceeds to ACT8. In ACT8, the processor 61 stores the company's reward point member number in the member number memory. The member number memory is formed in the volatile memory area of the main memory 62. In ACT5, the processor 61 sets the company's reward point flag Fa to “1”. Subsequently, the processing of the processor 61 proceeds to ACT21 of FIG. 6.

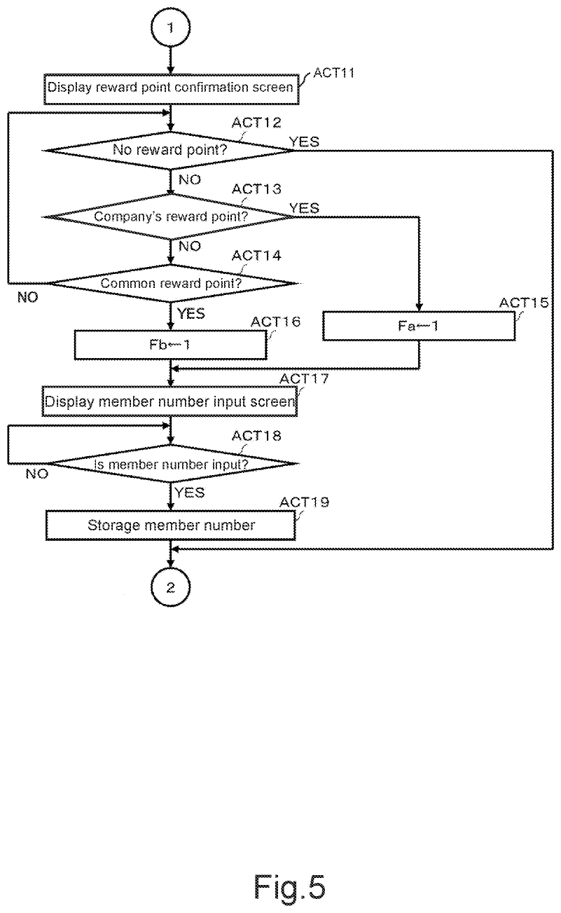

Meanwhile, if it is determined that the transaction file does not include a company's reward point member number (NO in ACTT), the processing of the processor 61 proceeds to ACT11 of FIG. 5. In ACT11, the processor 61 causes the touch panel 68 to display a reward point confirmation screen 80 (see FIG. 7).

FIG. 7 is a diagram showing a display example of the reward point confirmation screen 80. As shown in the figure, the reward point confirmation screen 80 is a screen on which a company's reward point button 81, a common reward point button 82, and a no-reward point button 83 are arranged as operating elements. The company's reward point button 81 is an operating element that is touched by a customer who receives company's reward points. The common reward point button 82 is an operating element that is touched by a customer who receives common reward points. The no-reward point button 83 is an operating element that is touched by a customer who is not given the company's reward points or common reward points. In other words, the reward point confirmation screen 80 is a screen for providing a notification for determining whether or not the customer has service specifying information for specifying a service to be provided to the customer. Further, the reward point confirmation screen 80 is a screen for waiting for an instruction input as to whether the customer has the service specifying information for specifying a service to be provided to the customer.

Here, the processor 61 implements the function as the confirmation module 613 by the processing in ACTT. Further, the processor 61 implements the function as the notification module 614 by the processing in ACT11.

In the reward point confirmation screen 80 of FIG. 7, a customer who is a company's reward point member and possesses the company's reward point card touches the company's reward point button 81. A customer who is a common reward point member and possesses a common reward point card touches the common reward point button 82. A customer who does not possess any reward point card touches the no-reward point button 83.

The processor 61, which has controlled the display of the reward point confirmation screen 80, waits for the no-reward point button 83 to be operated by determining whether or not the no-reward point button 83 has been operated in ACT12 of FIG. 5. The processor 61 also waits for the company's reward point button 81 to be operated by determining whether or not the company's reward point button 81 has been operated in ACT13. The processor 61 also waits for the common reward point button 82 to be operated by determining whether or not the common reward point button 82 has been operated in ACT14. In those standby states, when the no-reward point button 83 is operated (YES in ACT12), the processing of the processor 61 proceeds to ACT21 of FIG. 6.

Meanwhile, if it is determined that the company's reward point button 81 has been operated (YES in ACT13), the processor 61 proceeds to ACT15. In ACT15, the processor 61 sets the company's reward point flag Fa to “1”. Similarly, if the common reward point button 82 is operated (YES in ACT14), the processor 61 proceeds to ACT16. In ACT16, the processor 61 sets the common reward point flag Fb to “1”.

After the processing in ACT15 or ACT16, the processing of the processor 61 proceeds to ACT17. In ACT17, the processor 61 causes the touch panel 68 to display a member number input screen. The member number input screen is a screen for receiving an input of the company's reward point member number or the common reward point member number. On the member number input screen, a numeric keypad necessary for inputting the member number is arranged.

The customer who has touched the company's reward point button 81 causes the reader/writer 70 to read the company's reward point card. Alternatively, the customer operates the numeric keypad to input the company's reward point member number stored in the company's reward point card. The customer who has touched the common reward point button 82 causes the reader/writer 70 to read the common reward point card. Alternatively, the customer operates the numeric keypad to input the common reward point member number stored in the common reward point card.

The processor 61, which has controlled the display of the member number input screen, waits for the member number to be input by determining whether or not the member number has been input in ACT18. When the reader/writer 70 reads the company's reward point card or the common reward point card or receives an operation input by the customer using the numeric keypad, the processor 61 determines that the company's reward point member number or the common reward point member number has been input (YES in ACT18). The processing of the processor 61 then proceeds to ACT19. In ACT19, the processor 61 stores the member number in the member number memory (the volatile memory area of the main memory 62). In other words, if the reader/writer 70 reads the company's reward point card, the processor 61 stores the company's reward point member number, which is recorded in the company's reward point card, in the member number memory. If the reader/writer 70 reads the common reward point card, the processor 61 stores the common reward point member number, which is recorded in the common reward point card, in the member number memory. If the company's reward point member number or the common reward point member number is input by the operation input of the numeric keypad, the processor 61 stores the company's reward point member number or the common reward point member number in the member number memory.

Here, the processor 61 implements the function as the reception module 615 by the processing in ACT17 and ACT19.

Subsequently, the processing of the processor 61 proceeds to ACT21 of FIG. 6. As described above, the processing of the processor 61 proceeds to ACT21 of FIG. 6 when the processing of ACT5 of FIG. 4 is completed, when it is determined that the no-reward point button 83 of the reward point confirmation screen 80 is operated (YES in ACT12 of FIG. 5), or when the processing of ACT19 of FIG. 5 is completed.

In ACT21, the processor 61 causes the touch panel 68 to display a payment method selection screen. The payment method selection screen is a screen on which payment method selection buttons such as a cash button, a credit button, and an electronic money button are arranged as operating elements. The cash button is touched by a customer who selects cash as a payment method. The credit button is touched by a customer who selects a credit card as a payment method. The electronic money button is touched by a customer who selects electronic money as a payment method. Note that the payment method is not limited to the three types of cash, credit card, and electronic money. Any two types of them may be used, or another payment method may be selectable. Alternatively, one type of the payment method may be provided. In this case, instead of the payment method selection button, an operating element for instructing the start of payment, for example, a payment start button, may be displayed on the payment method selection screen.

In ACT22, the processor 61 waits for the payment method to be selected by determining whether or not the payment method has been selected. If it is determined that any of the payment methods has been selected by the operation on the payment method selection screen (YES in ACT22), the processing of the processor 61 proceeds to ACT23. In ACT23, the processor 61 executes the payment processing. For example, if cash is selected as the payment method, the processor 61 calculates a change by subtracting the total amount from the amount input to the automated change machine, and executes the processing of paying out the change from the automated change machine. For example, if the credit card is selected as the payment method, the processor 61 authenticates the credit card read by the reader/writer 70, and determines the total amount as the credit payment amount on condition that the credit card is approved. For example, if electronic money is selected as the payment method, the processor 61 subtracts the total amount from the balance of the electronic money medium read by the reader/writer 70.

Here, the processor 61 implements the function as the payment module 617 by the processing in ACT21 to ACT23.

After the payment processing, in ACT24, the processor 61 checks the company's reward point flag Fa. If it is determined that the company's reward point flag Fa is set to “1” (YES in ACT24), the processing of the processor 61 proceeds to ACT25. In ACT25, the processor 61 calculates the company's reward points. For example, the processor 61 divides the total amount of the commodity sales data stored in the transaction file by a predetermined reward point reference amount, and multiplies the integer of the quotient by a predetermined reward point magnification to calculate the company's reward points. The reward point reference amount and the reward point magnification are set by the company's reward point server 3. For example, assuming that the company's reward point service is a service for giving one reward point for each total amount of 100 yen, the company's reward point server 3 sets 100 yen as the reward point reference amount and sets one-fold as the reward point magnification. Further, for example, assuming that it is a special selling period of the store and the company's reward points are given twice the usual, the company's reward point server 3 sets 100 yen as the reward point reference amount and sets twice as the reward point magnification.

After calculating the company's reward points, in ACT26, the processor 61 executes company's reward point update processing. The company's reward point update processing is processing in which, together with the member number stored in the member number memory (the volatile memory area of the main memory 62), that is, the company's reward point member number, the data of the company's reward points calculated by the processing in ACT25 is transmitted to the company's reward point server 3 and the updating is notified. Upon receiving this notification, the company's reward point server 3 executes processing of adding the company's reward points currently obtained to the cumulative reward points stored in the database in association with the company's reward point member number.

In ACT24, if it is determined that the company's reward point flag Fa is not set to “1”, or if the processing in ACT26 is completed, the processing of the processor 61 proceeds to ACT27. In ACT27, the processor 61 checks the common reward point flag Fb. If it is determined that the common reward point flag Fb is set to “1” (YES in ACT27), the processing of the processor 61 proceeds to ACT28. In ACT28, the processor 61 calculates the common reward points. For example, the processor 61 divides the total amount of the commodity sales data stored in the transaction file by a predetermined reward point reference amount, and multiplies the integer of the quotient by a predetermined reward point magnification to calculate the common reward points. The reward point reference amount and the reward point magnification are set by the common reward point server 4. For example, assuming that the common reward point service is a service for giving one reward point for each total amount of 200 yen, the common reward point server 4 sets 200 yen as the reward point reference amount and sets one-fold as the reward point magnification. Further, for example, assuming that it is a campaign period of a common reward point management company and the common reward points are given five times the usual, the common reward point server 4 sets 200 yen as the reward point reference amount and sets five times as the reward point magnification.

After calculating the common reward points, in ACT29, the processor 61 executes common reward point update processing. The common reward point update processing is processing in which, together with the member number stored in the member number memory (the volatile memory area of the main memory 62), that is, the common reward point member number, the data of the common reward points calculated by the processing in ACT28 is transmitted to the common reward point server 4 and the updating is notified. Upon receiving this notification, the common reward point server 4 executes processing of adding the common reward points currently obtained to the cumulative reward points stored in the database in association with the common reward point member number.

Here, the processor 61 implements the function as the providing module 616 by the processing in ACT24 to ACT29.

In ACT27, if it is determined that the common reward point flag Fb is not set to “1” (YES in ACT27), or if the processing in ACT29 is completed, the processing of the processor 61 proceeds to ACT30. In ACT30, the processor 61 controls the issuance of a receipt by the printer 69. On the receipt, transaction detail data such as a commodity name, a price, the number of commodities sold, the sales amount, the total number of commodities, the total amount, the payment amount, and the like of the commodities to be purchased is printed. In addition, for the transaction in which the company's reward points or the common reward points are given, the given reward points are printed on the receipt. The processor 61, which has controlled the issuance of the receipt, terminates the information processing shown in FIGS. 4 to 6.

[Actions and Effects of Checkout Machine]

As described in detail above, the checkout machine 14, which is one aspect of the payment apparatus, executes the company's reward point update processing together with the payment processing if the data of the company's reward point member number is included in the data of the transaction file acquired from the virtual POS server 13. As described above, the checkout machine 14 invariably executes the processing of providing the company's reward points at the time of payment in the transaction with a customer who has registered his/her company's reward point member number in the shopping support terminal 2 in advance.

Therefore, the customer who has registered his/her company's reward point member number in the shopping support terminal 2 in advance uses the checkout machine 14 to pay for the transaction in which the registration operation of the commodities to be purchased has been performed using the shopping support terminal 2, whereby the customer can surely obtain the company's reward points corresponding to the content of the transaction.

On the other hand, if the data of the company's reward point member number is not included in the data of the transaction file, the checkout machine 14 displays the reward point confirmation screen 80 before displaying the payment method selection screen. As described above, the checkout machine 14 displays the reward point confirmation screen 80 before the payment in the transaction with a customer who has not registered his/her company's reward point member number in advance, and confirms with the customer whether to receive the company's reward point service or the common reward point service.

Here, if the customer touches the company's reward point button 81 and subsequently inputs the company's reward point member number, the checkout machine 14 executes the payment processing and the company's reward point update processing. If the customer touches the common reward point button 82 and subsequently inputs the common reward point number, the checkout machine 14 executes the payment processing and the common reward point update processing. If the customer inputs the no-reward point button 83, the checkout machine 14 performs the payment processing and does not perform the company's reward point update processing or the common reward point update processing.

Therefore, even if the customer has not registered the company's reward point member number in advance, the customer uses the checkout machine 14 to pay for the transaction in which the registration operation of the commodities to be purchased has been performed using the shopping support terminal 2, whereby the customer can surely obtain the company's reward points or the common reward points corresponding to the content of the transaction.

A customer who uses the company's reward point card and the common reward point card can choose to receive the company's reward points or common reward points for each transaction. For example, the customer can easily choose to receive the company's reward points with a small reward point reference amount in a normal case, or to receive the common reward points during periods in which the reward point magnification of the common reward points is high.

### Other Embodiments

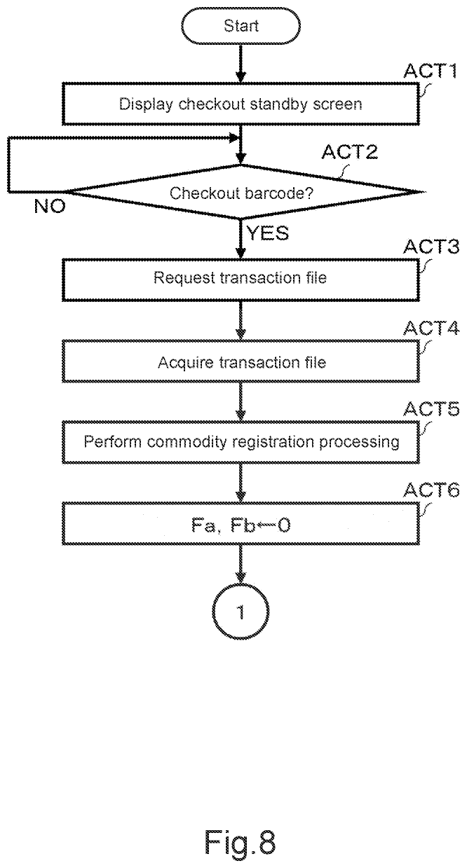

FIG. 8 is a flowchart showing a part of the information processing executed by the processor 61 of the checkout machine 14 in accordance with a payment program in another embodiment. In other words, the processor 61 performs the same processing as that of the above embodiment in ACT1 to ACT6, and then performs the processing of ACT11 of FIG. 5 without performing the processing of ACTT. In other words, the processor 61 causes the touch panel 68 to display the reward point confirmation screen 80 in ACT11 regardless of whether or not the service specifying information is included in the transaction file. Subsequently, the processing of ACT11 to ACT19 in FIG. 5 and the processing in ACT21 to ACT30 of FIG. 6 are executed as in the above embodiment.

Also in this embodiment, it is possible to provide the checkout machine 14 that can execute the processing of surely providing a service for a transaction with a customer who can receive a service such as reward points. This embodiment is effective when the shopping support terminal 2 does not have the function of registering the service specifying information such as the company's reward point member number in advance. For example, there is a transaction processing system in which a portable terminal provided by a store to a customer or a tablet terminal attached to a shopping cart is used as the shopping support terminal 2 instead of a smartphone owned by the customer. In such a system, many customers are reluctant to input their service specifying information such as a reward point member number to a portable terminal or a tablet terminal used by an unspecified number of customers. In this embodiment, since it is not necessary to input the service specifying information to the shopping support terminal 2, it is very effective from the viewpoint of security. In this embodiment, the processor 61 of the checkout machine 14 can omit the function as the confirmation module 613.

In the above embodiment, the transaction processing system 1 established in a store that employs both the company's reward point service system and the common reward point service system has been exemplified. It is also possible to apply the transaction processing system 1 to a store that employs either the company's reward point service system or the common reward point service system. In this case, either the company's reward point button 81 or the common reward point button 82 is arranged on the reward point confirmation screen 80.

The transaction processing system 1 can also be applied to a store that employs two or more types of common reward point service systems. In this case, the reward point confirmation screen 80 on which the common reward point button 82 is arranged for each type of common reward points is displayed.

Further, the service specifying information registered in the shopping support terminal 2 is not limited to the company's reward point member number. Even in the operation in which the common reward point member number can be registered in advance in the shopping support terminal 2, the transaction processing system 1 can be applied by setting the common reward point flag Fb to “1” in the processing of ACT5 of FIG. 4.

In the above embodiment, the checkout barcode is obtained by barcoding the terminal identification information of the shopping support terminal 2 in a predetermined barcode system. The checkout barcode is not limited to the above. The checkout barcode only needs to be unique to the transaction file.

Note that in the above embodiment the checkout machine 14 detects the checkout barcode from the shopping support terminal 2 and acquires the transaction file associated with the checkout barcode from the virtual POS server 13. The method of acquiring the transaction file is not limited to this. For example, a checkout machine code including a barcode or a two-dimensional code system is prepared in the vicinity of the checkout machine 14. The checkout machine code is a coded checkout machine ID set in the checkout machine 14. The customer who has finished shopping and moved to the front of the checkout machine 14 causes the camera of the shopping support terminal 2 to read the checkout machine code. Then, the shopping support terminal 2 transmits the terminal identification information and the checkout machine code to the virtual POS server 13. The virtual POS server 13 transmits the transaction file associated with the terminal identification information to the checkout machine 14 specified by the checkout machine code. In such a manner, the checkout machine 14 can obtain the transaction file. In this case, the processor 61 of the checkout machine 14 can omit the detection module 611.

The service provided to the customer is not limited to the reward points. For example, the checkout machine 14 can be applied to a service in which an electronic stamp is provided to a customer every time there is a transaction, by simply changing the reward point calculation processing to electronic stamp issuing processing and changing the reward point update processing to electronic stamp book update processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A payment apparatus that performs payment processing on a basis of a data file in which data relating to sale of a commodity is recorded, the data being input through a terminal operated by a customer in a sales floor, the payment apparatus comprising:
a communication interface that exchanges the data with a server that creates the data file;
an input device that displays a screen for providing a notification to the customer and receives an instruction input made by the customer in response to the notification;
a memory that stores service specifying information for specifying a service to be provided to the customer; and
a processor that
acquires the data file from the server via the communication interface,
provides the customer with a notification for determining whether or not the customer has the service specifying information for specifying a service to be provided to the customer using the input device on condition that the data file is acquired, and waits for an instruction input made by the customer as to whether the customer has the service specifying information,
acquires the service specifying information and causes the memory to store the service specifying information when the input device receives an instruction input indicating that the customer has the service specifying information in responses to the notification,
performs processing for providing the service specified by the stored service specifying information to the customer, and
executes payment processing on a basis of the data of the acquired data file after the input device receives an instruction input indicating that the customer does not have the service specifying information or receives an input of the service specifying information in responses to the notification.

2. The payment apparatus according to claim 1, wherein
the data file is associated with a code for identifying the terminal.

3. The payment apparatus according to claim 2, wherein
the processor
detects the code associated with the data file from the terminal, and
acquires the data file associated with the detected code from the server.

4. The payment apparatus according to claim 3, further comprising
a scanner that reads the code, wherein
the processor detects the code displayed on the terminal by the scanner.

5. The payment apparatus according to claim 1, wherein
the processor
determines whether or not the acquired data file includes the service specifying information, and
provides the notification if the data file does not include the service specifying information.

6. The payment apparatus according to claim 5, wherein
the processor performs, if the data file includes the service specifying information, processing for providing the service specified by the included service specifying information to the customer without performing the notification.

7. The payment apparatus according to claim 6, wherein
the processor
causes the memory to store the included service specifying information if the data file includes the service specifying information, and
performs the processing for providing the service specified by the stored service specifying information to the customer.

8. The payment apparatus according to claim 5, wherein
the processor determines whether or not the customer has at least one piece of service specifying information for specifying a service for each of different types of services.

9. The payment apparatus according to claim 8, wherein
the processor
causes the input device to display a confirmation screen for determining whether or not the customer has the at least one piece of service specifying information for specifying a service for each of different types of services, and
causes the input device to display, if it is determined that the customer has the at least one piece of service specifying information from the confirmation screen, an input screen for receiving from the customer an input of the service specifying information determined to be owned by the customer.

10. A payment method for a payment apparatus that performs payment processing on a basis of a data file in which data relating to sale of a commodity is recorded, the data being input through a terminal operated by a customer in a sale floor, the payment method comprising:
exchanging, by a communication interface, the data with a server that creates the data file;
acquiring the data file from the server via the communication interface;
providing the customer with a notification for determining whether or not the customer has service specifying information for specifying a service to be provided to the customer using an input device on condition that the data file is acquired, and waiting for an instruction input made by the customer as to whether the customer has the service specifying information;
acquiring the service specifying information and causing a memory to store the service specifying information when the input device receives an instruction input indicating that the customer has the service specifying information in responses to the notification;
performing processing for providing the service specified by the stored service specifying information to the customer; and
executing payment processing on a basis of the data of the acquired data file after the input device receives an instruction input indicating that the customer does not have the service specifying information or receives an input of the service specifying information in responses to the notification.
